(19) United States
(12) Patent Application Publication
(10) Pub. No.: US 2025/0226459 A1
(43) Pub. Date: Jul. 10, 2025

(54) SOLID-STATE BATTERY

(71) Applicant: Murata Manufacturing Co., Ltd., Nagaokakyo-shi (JP)

(72) Inventor: Ryohei TAKANO, Nagaokakyo-shi (JP)

(21) Appl. No.: 19/089,289

(22) Filed: Mar. 25, 2025

Related U.S. Application Data
(63) Continuation of application No. PCT/JP2023/029432, filed on Aug. 14, 2023.

(30) Foreign Application Priority Data
Sep. 28, 2022 (JP) 2022-155351

(51) Int. Cl. H01M 10/42; H01M 10/052; H01M 10/0562

(52) U.S. Cl. CPC H01M 10/4235; H01M 10/052; H01M 10/0562; H01M 2300/0071; H01M 2300/0094

(57) ABSTRACT

A solid-state battery having an exterior portion. The exterior portion includes an oxide ceramic containing: Li (lithium); Mg (magnesium); and one or more elements (M) selected from Group 4 and Group 5 elements.

### CROSS REFERENCE TO RELATED APPLICATIONS

The present application is a continuation of International application No. PCT/JP2023/029432, filed Aug. 14, 2023, which claims priority to Japanese Patent Application No. 2022-155351, filed Sep. 28, 2022, the entire contents of each of which are incorporated herein by reference.

### TECHNICAL FIELD

The present disclosure relates to a solid-state battery.

### BACKGROUND ART

In recent years, the demand for batteries as power sources for portable electronic devices such as mobile phones and portable personal computers has been greatly expanded. In batteries used for such applications, an electrolyte (electrolytic solution) such as an organic solvent has been conventionally used as a medium for moving ions. However, a battery having the above configuration has a risk of leakage of the electrolytic solution. In addition, the organic solvent or the like used as the electrolytic solution is a combustible substance. Therefore, it is required to enhance the safety of the battery.

Therefore, in order to enhance the safety of the battery, a solid-state battery using a solid electrolyte as an electrolyte instead of the electrolytic solution has been studied.

For example, Patent Documents 1 to 4 propose a solid-state battery having an exterior portion containing an oxide ceramic on an outer surface of a battery element including a positive electrode layer, a negative electrode layer, and a solid electrolyte layer therebetween.
Patent Document 1: WO 2019/167856 A
Patent Document 2: Japanese Patent Application Laid-Open No. 2007-173212
Patent Document 3: Japanese Patent Application Laid-Open No. 2003-92092
Patent Document 4: WO 2019/181909 A

### SUMMARY OF THE DISCLOSURE

However, the inventor of the present disclosure has found that the conventional solid-statebattery described above has the following new problem.

When the oxide ceramic included in the exterior portion contains no Li ions, the solid electrolyte contained in the battery element reacts with the oxide ceramic, the solid electrolyte is decomposed, and a by-product is generated. In particular, when a highly reactive solid electrolyte having a garnet type or LISICON type crystal structure is used, the solid electrolyte is easily decomposed.

Therefore, Li ions are contained in the oxide ceramic, and as a result, it has been found that this side reaction can be suppressed. However, the formation of the exterior portion including the oxide ceramic containing Li ions deteriorated the moisture resistance of the exterior portion itself.

An object of the present disclosure is to provide a solid-state battery having an exterior portion including an oxide ceramic that can form an exterior portion being sufficiently excellent in moisture resistance and being more sufficiently excellent in reaction resistance to a solid electrolyte.

The present disclosure relates to a solid-state battery having an exterior portion including an oxide ceramic containing: Li (lithium); Mg (magnesium); and one or more elements (M) selected from Group 4 and Group 5 elements.

The present disclosure can provide a solid-state battery having an exterior portion including an oxide ceramic that can form an exterior portion being sufficiently excellent in moisture resistance and being more sufficiently excellent in reaction resistance to a solid electrolyte.

### BRIEF EXPLANATION OF THE DRAWINGS

FIG. 1 is a schematic view showing an example of a solid-state battery of the present disclosure, and is a composite view of a perspective view and a sectional view.

FIG. 2 is a schematic perspective view showing another example of a solid-state battery of the present disclosure.

FIG. 3 shows XRD measurement result data when reaction resistance is determined in Example 4.

### DESCRIPTION OF THE PREFERRED EMBODIMENTS

### [Solid-State Battery]

The present disclosure provides a solid-state battery. The term “solid-state battery” as used herein refers in a broad sense to a battery in which its components (particularly an electrolyte layer) are constituted of solids, and refers in a narrow sense to an “all-solid-state battery” in which its components (particularly all the components) are constituted of solids. In one preferred embodiment, the solid-state battery according to the present disclosure is a stacked solid-state battery in which the respective layers forming the battery constituent unit are stacked on each other, and preferably each of such layers is made of a sintered body. The “solid-state battery” as used herein includes what is called a “secondary battery” capable of repeating charging and discharging, and a “primary battery” capable of discharging only. In one preferred embodiment of the present disclosure, the “solid-state battery” is a “secondary battery”. The “secondary battery” is not excessively limited by its name, and can encompass, for example, an electrochemical device such as a “power storage device”. The term “solid electrolyte” as used herein refers to one that includes no gel-like or liquid electrolyte (liquid).

The term “plan view” in the present specification refers to a state (a top view or a bottom view) when an object is viewed from the upper side or the lower side along a thickness direction based on a stacking direction of layers described later and constituting the solid-state battery. In addition, the “sectional view” as used herein refers to a sectional state (sectional view) when viewed from a direction substantially perpendicular to the thickness direction based on the stacking direction L of the layers to be described later that constitute the solid-state battery. The “side view” is a state when the solid-state battery is mounted and viewed from the side of a thickness (height) direction thereof, and means the same as lateral view. The mounting is a mounting with a surface (planar surface) of the maximum area constituting the appearance of the solid-state battery being a bottom surface. The “vertical direction” and “horizontal direction” as used directly or indirectly herein correspond to a vertical direction and a horizontal direction in the drawings, respectively. Unless otherwise specified, the same reference signs or symbols shall denote the same members or sites or the same meanings. In a preferred embodiment, it can be grasped that a vertical downward direction (that is, a direction in which gravity acts) corresponds to a “downward direction”, and the opposite direction corresponds to an “upward direction”.

The solid-state battery of the present disclosure may have any shape in a plan view, and typically has a rectangular shape. The rectangular shape encompasses squares and rectangles.

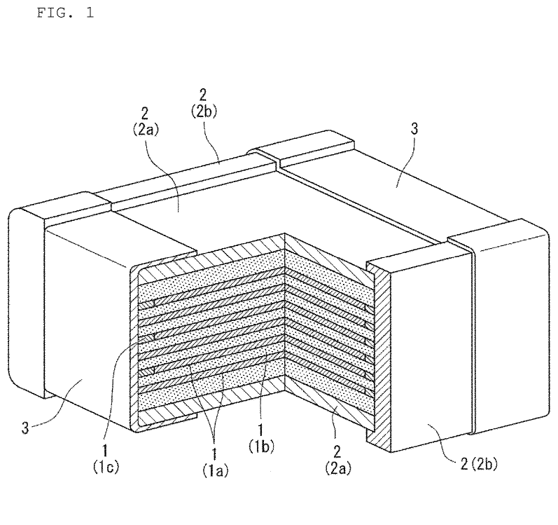

The solid-state battery of the present disclosure has, for example, a layered structure (particularly, a stacked structure) as shown in FIG. 1. The solid-state battery of the present disclosure has a battery element 1 and an exterior portion 2 covering a surface of the battery element 1, and typically further has an external electrode 3 for drawing electric power (particularly current) generated in the battery element to the outside. FIG. 1 is a schematic sectional view showing an example of a solid-state battery of the present disclosure.

### (Exterior Portion)

The exterior portion 2 is a member covering the outside of the battery element 1, and has a function of covering the battery element 1 to prevent entry of moisture into the battery element 1. The exterior portion 2 typically has not only such a function but also a function of electrically, physically, and chemically protecting a battery element, and thus may also be referred to as a protective layer or a protective film. The exterior portion 2 includes a main surface exterior portion 2a (for example, a set of main surface exterior portions 2a) that covers the main surface of the battery element 1 and a side surface exterior portion 2b (for example, a set of side surface exterior portions 2b) that covers the side surface of the battery element 1. The exterior portion 2 typically has a layer form or a film form. The exterior portion 2 may be in direct contact with the surface (in particular, the main surface and/or the side surface) of the battery element 1, or may be in indirect contact with the surface with another layer (or film) interposed therebetween. From the viewpoint of more sufficiently exhibiting the effect of the present disclosure, it is preferable that the exterior portion 2 is in direct contact with the surface (particularly, the main surface and/or the side surface) of the battery element 1.

In the solid-state battery of the present disclosure, the exterior portion 2 includes a specific oxide ceramic. In the present disclosure, at least one of the main surface exterior portion and the side surface exterior portion may include a specific oxide ceramic. From the viewpoint of further improving the moisture resistance and the reaction resistance, it is preferable that both the main surface exterior portion and the side surface exterior portion include a specific oxide ceramic.

In the present specification, the moisture resistance is a property of preventing entry of moisture, and may be a property of being hardly affected by moisture particularly under high temperature and high humidity (for example, resistance to moisture absorption).

The reaction resistance is a property that the exterior portion (particularly, the oxide ceramic included in the exterior portion) hardly reacts (for example, side reaction) when fired (for example, at 800° C. for 5 hours) with the solid electrolyte included in the battery element. The reaction resistance may be a property that the oxide ceramic and the solid electrolyte hardly react each other particularly when fired together.

In the present disclosure, the oxide ceramic included in the exterior portion contains: Li (lithium); Mg (magnesium); and one or more elements (M) selected from the group consisting of Group 4 and Group 5 elements. Specifically, the element M is one or more elements selected from the group consisting of Ti (titanium), Zr (zirconium), Hf (hafnium), Ta (tantalum), and Nb (niobium). The element M preferably includes Ti from the viewpoint of further improving the moisture resistance, and more preferably includes only Ti or includes Ti and Zr or Ta. In the present disclosure, the oxide ceramic contains Li, Mg, and the element M in combination, thereby allowing to provide an exterior portion excellent in moisture resistance and reaction resistance. When the oxide ceramic does not include Li, does not include Mg, and does not include the element M, at least one of the properties of moisture resistance and reaction resistance is deteriorated.

In the oxide ceramic, the molar ratios Li/M and Mg/M are not particularly limited, and are preferably within the following ranges from the viewpoint of further improving the moisture resistance and the reaction resistance.
·Li/M
referably, 0<Li/M≤5;
more preferably, 0.8≤Li/M≤4.2; and
still more preferably, 0.8≤Li/M≤2.1.
·Mg/M
preferably, 0.1≤Mg/M≤9.8;
more preferably, 0.3≤Mg/M≤9.8; and
still more preferably, 0.8≤Mg/M≤4.2.

As Li/M and Mg/M in the oxide ceramic, there are used values obtained by calculating from the contents (or molar ratio) of Li, Mg, and M measured by the same method as the method for analyzing the chemical composition of the oxide ceramic described later.

The oxide ceramic may have any chemical composition as long as it has the above molar ratio. From the viewpoint of further improving the moisture resistance and the reaction resistance, the oxide ceramic preferably has a chemical composition represented by the following general formula (1).

L iₐ₁Aₐ₂Mg_{β}M_{γ}O_{δ} (1)

In the formula (1), A is one or more elements selected from the group consisting of Na, K, Rb, Ca, Sr, Ba, Sc, Y, Mo, W, Zn, Al, Ga, Ge, Sn, Sb, and Bi.

M is one or more elements selected from the same group as the element M described above, and from the viewpoint of further improving the moisture resistance, and preferably includes one or more elements selected from the group consisting of Ti, Zr, Hf, Nb, and Ta, more preferably includes Ti, and still more preferably includes only Ti, or includes Ti and Zr or Ta.

In the formula (1), α1/γ and β/γ correspond to the above-described molar ratios Li/M and Mg/M, respectively. Therefore, α1/γ satisfies the same range as the molar ratio Li/M described above, and from the viewpoint of further improving the moisture resistance and the reaction resistance, preferably satisfies the preferable range of Li/M, more preferably satisfies the more preferable range of Li/M, and still more preferably satisfies the further preferable range of Li/M. β/γ satisfies the same range as the molar ratio Mg/M described above, and from the viewpoint of further improving the moisture resistance and the reaction resistance, preferably satisfies the preferable range of Mg/M, more preferably satisfies the more preferable range of Mg/M, and still more preferably satisfies the further preferable range of Mg/M.

$$δ = \{ α 1 + a α 2 + 2 β + n γ \} / 2$$

(n is the average valence of M and M′, and a is the average valence of A)

Specifically, n is the average valence of M and M′. The average valence of M and M′ is, for example, the same value as the above-described average valence of A¹ in a case where the number of elements X having a valence of a+ is n1, the number of elements Y having a valence of b+ is n2, and the number of elements Z having a valence of c+ is n3 in the elements represented by B¹.

a is an average valence of A. The average valence of A is, for example, a value represented by (n1×a+n2×b+n3×c)/(n1+n2+n3) when the number of elements X having a valence of a+ is n1, the number of elements Y having a valence of b+ is n2, and the number of elements Z having a valence of c+ is n3 in the elements represented by A.

The oxygen number δ may be deviated from the above value by about ±10%. That is, oxygen deficiency or interstitial oxygen may be included in part.

In the formula (1), α1 typically satisfies 0<α1<1.0, and from the viewpoint of further improving the moisture resistance and the reaction resistance, preferably satisfies 0.15<α1<0.70, and more preferably satisfies 0.29≤α1≤0.50.

α2 typically satisfies 0≤α2≤1.0, and from the viewpoint of further improving the moisture resistance and the reaction resistance, preferably satisfies 0≤α2≤0.5 and is more preferably 0.

β typically satisfies 0<β<1.0, and from the viewpoint of further improving the moisture resistance and the reaction resistance, preferably satisfies 0.03≤β<0.85, and more preferably satisfies 0.25≤β≤0.60.

γ typically satisfies 0<γ<1.0, and from the viewpoint of further improving the moisture resistance and the reaction resistance, preferably satisfies 0.05<γ<0.35, and more preferably satisfies 0.14≤γ≤0.26.

The chemical composition of the oxide ceramic can be determined by ICP analysis (inductively coupled plasma method), LA-ICP-MS (laser ablation ICP mass spectrometry) analysis, or the like. EDX (energy dispersive X-ray spectroscopy) or WDX (wavelength dispersive X-ray spectroscopy) may be used. The chemical composition may be obtained by performing quantitative analysis (composition analysis) at arbitrary 100 points of each of arbitrary 100 sintered grains and calculating the average of the resulting values.

The crystal structure of the oxide ceramic is not particularly limited, and may have, for example, a rock salt type crystal structure, a spinel type crystal structure, a layered rock salt type crystal structure, or a mixed phase structure thereof. From the viewpoint of further improving the moisture resistance and the reaction resistance, the oxide ceramic preferably has a rock salt type crystal structure and/or a spinel type crystal structure (particularly a rock salt type crystal structure or a mixed phase structure of a rock salt type crystal structure and a spinel type crystal structure), and more preferably has a rock salt type crystal structure.

The statement that the oxide ceramic has a rock salt type crystal structure means that the oxide ceramic has not only a “crystal structure of a rock salt type” but also a “crystal structure resembling a rock salt type”. Specifically, the oxide ceramic has a crystal structure that can be recognized as a crystal structure of a rock salt type or resembling a rock salt type by those skilled in the art of solid-state batteries in X-ray diffraction. More specifically, the oxide ceramic may show, in X-ray diffraction, one or more main peaks corresponding to a Miller index unique to a so-called crystal structure of a rock salt type, diffraction pattern: ICDD Card No. 00-004-0829, at a predetermined incident angle, or as a rock salt-like crystal structure, one or more main peaks corresponding to a Miller index unique to a so-called crystal structure resembling a rock salt type may show one or more main peaks having different incident angles (that is, peak positions or diffraction angles) and intensity ratios (that is, peak intensities or diffraction intensity ratios) due to a difference in composition. Examples of a typical diffraction pattern of a crystal structure resembling a rock salt type include ICDD Card No. 00-036-0308.

The statement that the oxide ceramic has a spinel type crystal structure means that the oxide ceramic has not only a “crystal structure of a spinel type” but also a “crystal structure resembling a spinel type”. Specifically, the oxide ceramic has a crystal structure that can be identified as a crystal structure of a spinel type or resembling a spinel type by those skilled in the field of solid-state batteries in X-ray diffraction. More specifically, the oxide ceramic may show, in X-ray diffraction, one or more main peaks corresponding to a Miller index unique to a so-called crystal structure of a spinel type (diffraction pattern: ICDD Card No. 01-072-6998) at a predetermined incident angle, or as a crystal structure resembling a spinel type, one or more main peaks corresponding to a Miller index unique to a so-called crystal structure of a spinel type may show one or more main peaks having different incident angles (that is, peak positions or diffraction angles) and intensity ratios (that is, peak intensities or diffraction intensity ratios) due to a difference in composition.

The mixed phase structure in which the oxide ceramic has a rock salt type crystal structure and a spinel type crystal structure means that the oxide ceramic contains an oxide ceramic having both crystal structures of the rock salt type crystal structure and the spinel type crystal structure described above.

The statement that the oxide ceramic has a layered rock salt type crystal structure means that the oxide ceramic has not only a “crystal structure of a layered rock salt type” but also a “crystal structure resembling a layered rock salt type”. Specifically, the oxide ceramic has a layered crystal structure that can be recognized as a crystal structure of a layered rock salt type or resembling a layered rock salt type by those skilled in the art of solid-state batteries in X-ray diffraction. More specifically, the oxide ceramic may show, in X-ray diffraction, one or more main peaks corresponding to a Miller index unique to a so-called crystal structure pf a layered rock salt type, diffraction pattern: ICDD Card No. 00-033-0831, at a predetermined incident angle, or as a crystal structure resembling a layered rock salt type, one or more main peaks corresponding to a Miller index unique to a so-called crystal structure of a layered rock salt type may show one or more main peaks having different incident angles (that is, peak positions or diffraction angles) and intensity ratios (that is, peak intensities or diffraction intensity ratios) due to a difference in composition. Examples of a typical diffraction pattern of a crystal structure resembling a layered rock salt type include ICDD Card No. 00-033-0843.

The oxide ceramic may be produced by any method as long as the method can produce an oxide ceramic of the desired composition. For example, the oxide ceramic can be obtained by weighing out raw materials including a Li source, a Mg source, and an element M source so as to provide a desired composition, thoroughly mixing with water, and then firing. The firing temperature is not particularly limited, and may be, for example, 800° C. to 1200° C. (particularly, 850° C. or less and 1100° C. or less). The firing time is not particularly limited, and may be, for example, 1 hour to 10 hours (particularly 3 hours to 7 hours). As a Li source, for example, lithium carbonate (Li₂CO₃) can be used. As a Mg source, for example, magnesium oxide (MgO) can be used. As an element M source, for example, titanium oxide (TiO₂), niobium oxide (Nb₂O₅), zirconium oxide (ZrO₂), tantalum oxide (Ta₂O₅), and hafnium oxide (HfO₂) can be used. In the production of the oxide ceramic, the final composition of the obtained oxide ceramic is determined by the ratio of the Li source, Mg source, and element M source during charging. Therefore, adjusting the charging ratio of the Li source, the Mg source, and the element M source can control the above-described molar ratios Li/M and Mg/M.

The present disclosure does not preclude the exterior portion 2 from including another oxide ceramic in addition to the specific oxide ceramic described above. Another oxide ceramic includes an oxide including Bi. Examples thereof include a Li—Bi—O based oxide, a Li—Mg—Bi—O based oxide, Bi₂O₃, and a Mg—Bi—O based oxide. The content of the specific oxide ceramic in the exterior portion 2 may typically be an area percentage of 60% to 100%, and particularly an area percentage of 90% to 100%. The area percentage can be measured as follows. First, a solid-state battery is broken such that the broken surface of the ceramic exterior portion is exposed. This broken surface is polished using a cross-section polisher or the like to provide a polished surface. EDX analysis is performed on any surface in the region of the exterior portion of the polished surface, and the region in which not only Mg, element M, and element A are detected but also Li is detected by TOF-SIMS is regarded as the region of the specific oxide ceramic described above. As described above, the measurement can be possible by calculating the percentage of the area of the oxide ceramic to the area of the exterior portion.

The thickness of the exterior portion 2 is typically preferably 1 μm to 500 μm, more preferably 5 μm to 100 μm, and still more preferably 5 μm to 50 μm. As the thickness of the exterior portion 2, an average thickness for the thickness at arbitrary 100 positions is used.

The relative density of the exterior portion 2 is typically 90% to 100%, and preferably 95% to 100%. The relative density of the exterior portion may be measured using the Archimedes method.

The exterior portion 2 typically has an insulating property. The insulating property is a property having neither ion conductivity nor electron conductivity. For example, the ion conductivity of the exterior portion 2 is typically 1×10⁻⁷ S/cm or less, and particularly the ion conductivity is 1×10⁻¹⁰ S/cm or less. The ion conductivity of the exterior portion 2 is typically 1×10⁻¹⁸ S/cm or more. For example, the electron conductivity of the exterior portion 2 is typically 1×10⁻⁷ S/cm or less, particularly 1×10⁻¹⁰ S/cm or less. The electron conductivity of the exterior portion 2 is typically 1×10⁻¹⁸ S/cm or more.

The oxygen permeability of the exterior portion 2 in the thickness direction may be, for example, 10⁻¹ cc/m²/day/atmospheric pressure or less, particularly 10⁻³ cc/m²/day/atmospheric pressure or less.

H₂O permeability in the thickness direction of the exterior portion 2 may be, for example, 10⁻² g/m²/day or less, particularly 10⁻⁴ g/m²/day or less. As the H₂O permeability, a value measured at 25° C. by a cup method, a carrier gas method, a pressure deposition method, or a Ca corrosion method is used.

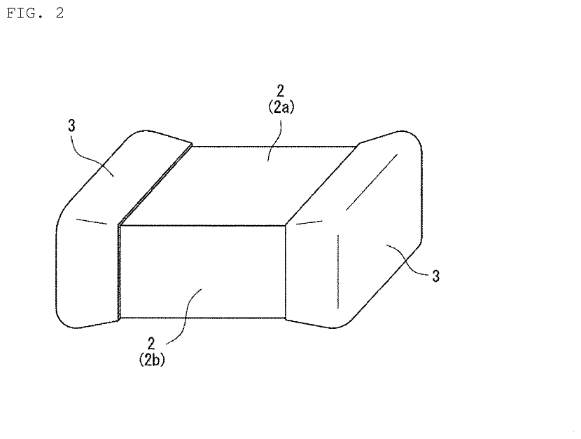

The main surface exterior portion 2a and the side surface exterior portion 2b have a form as separate members from each other (or a separate member structure) in FIG. 1, but may have a form in which the main surface exterior portion 2a and the side surface exterior portion 2b are integrated (or an integrated structure) as illustrated in FIG. 2. FIG. 2 is a schematic perspective view showing another example of a solid-state battery of the present disclosure. The solid-state battery of FIG. 2 is the same as the solid-state battery of FIG. 1 except that the main surface exterior portion 2a and the side surface exterior portion 2b are integrated. In the solid-state battery of FIG. 2, not only the main surface exterior portion 2a but also the side surface exterior portion 2b can be produced by using a later-described method of sticking a sheet (green sheet method). In particular, by producing the solid-state battery (in particular, the exterior portion 2) using a sheet in which a sheet corresponding to the main surface exterior portion 2a and a sheet corresponding to the side surface exterior portion 2b are continuous, production of the solid-state battery (in particular, the exterior portion 2) is significantly simplified. In this case, the oxide ceramic included in the main surface exterior portion 2a typically has the same chemical composition as the oxide ceramic included in the side surface exterior portion 2b.

When being direct contact with the surface (particularly the main surface and/or the side surface) of the battery element 1, the exterior portion 2 is preferably integrally sintered as sintered bodies together with the surface. That is, it is preferable that the exterior portion 2 is an integrally sintered body as sintered bodies together with the surface (particularly, the main surface and/or the side surface) of the battery element 1. The statement that the exterior portion 2 is integrally sintered as sintered bodies together with the surface of the battery element 1 means that the exterior portion 2 and the battery element 1 are joined by sintering. Specifically, the exterior portion 2 and the battery element 1 are sintered integrally while both being a sintered body. Not the whole of the exterior portion 2 and the battery element 1 need to be strictly integrated, and a part thereof does not have to be integrated. It is sufficient that the exterior portion 2 and the battery element 1 are integrated as a whole.

### (Battery Element)

The battery element 1 is a body portion of a solid-state battery covered with the exterior portion 2, and includes one or more battery constituent units. The battery constituent unit means a minimum constituent unit capable of exhibiting a battery function, and includes a set of electrode layers 1a (specifically, one positive electrode layer and one negative electrode layer facing each other) and one solid electrolyte layer 1b disposed between the set of electrode layers 1a (that is, between the positive electrode layer and the negative electrode layer). The battery element 1 may have a single battery structure having only one battery constituent unit, or may have a multi-battery structure in which two or more battery constituent units are stacked along a stacking direction of each layer constituting each battery constituent unit. The electrode layer includes the positive electrode layer and the negative electrode layer. The battery element 1 typically has an insulating portion 1c for ensuring electrical non-contact between one electrode layer and an external electrode for drawing current from the other electrode layer to the outside. For example, the battery element 1 has an insulating portion 1c for ensuring electrical non-contact between the positive electrode layer and an external electrode (that is, an external negative electrode) for drawing current from the negative electrode layer to the outside. In addition, for example, the battery element 1 has an insulating portion 1c for ensuring electrical non-contact between the negative electrode layer and an external electrode (that is, an external negative electrode) for drawing current from the positive electrode layer to the outside. As shown in FIG. 1, the battery element typically has a solid electrolyte layer 1b on the top layer and bottom layer of the battery element.

The battery element typically includes a solid electrolyte (hereinafter, may be referred to as a first solid electrolyte). The first solid electrolyte included in the battery element may have any crystal structure, for example, a garnet type crystal structure, a LISICON type crystal structure, a perovskite type crystal structure, or a mixed phase structure thereof. From the viewpoint of further improving moisture resistance and reaction resistance, the first solid electrolyte included in the battery element preferably has a garnet type crystal structure, a LISICON type crystal structure, or a mixed phase structure thereof, and more preferably has a garnet type crystal structure. The reactivity with the oxide ceramic of the exterior portion increases in the order of the solid electrolyte having a perovskite type crystal structure, the solid electrolyte having a LISICON type crystal structure, and the solid electrolyte having a garnet type crystal structure, and if the battery element contains such solid electrolytes, the oxide ceramic of the exterior portion can more sufficiently suppress the reaction with the solid electrolyte.

When the battery element includes such a first solid electrolyte, the first solid electrolyte may be included in one or more layers selected from a positive electrode layer, a negative electrode layer, and a solid electrolyte layer. From the viewpoint of further improving moisture resistance and reaction resistance, it is preferable that such a first solid electrolyte is included at least in the solid electrolyte layer.

The fact that the solid electrolyte has a garnet type crystal structure means, in an encompassing manner, that the solid electrolyte not only simply has a “crystal structure of a garnet type”, but also has a “crystal structure resembling a garnet type”. Specifically, the solid electrolyte has a crystal structure that can be identified as a crystal structure of a garnet type or resembling a garnet type by those skilled in the field of solid-state batteries in X-ray diffraction. More specifically, the solid electrolyte may show, in X-ray diffraction, one or more main peaks corresponding to a Miller index unique to a so-called crystal structure of a garnet type, diffraction pattern: ICDD Card No. 422259, at a predetermined incident angle, or as a crystal structure resembling a garnet type, one or more main peaks corresponding to a Miller index unique to a so-called crystal structure of a garnet type may show one or more main peaks having different incident angles (that is, peak positions or diffraction angles) and intensity ratios (that is, peak intensities or diffraction intensity ratios) due to a difference in composition. Examples of a typical diffraction pattern of a crystal structure resembling a garnet type include ICDD Card No. 00-045-0109.

The solid electrolyte having a garnet type crystal structure may have any chemical composition. The garnet type solid electrolyte has, for example, a chemical composition represented by the following general formula (2).

$$( {Li}_{p} {A}_{y}^{1} ) ( La \text{?} {B}_{2}^{1} ) ( {D}_{γ - x}^{1} {Bi}_{x} ) {O}_{12 - δ} \qquad ( 2 )$$

$$\text{?} \text{indicates text missing or illegible when filed}$$

In the formula (2), A¹ represents a metal element occupying a Li site in a garnet type crystal structure. A¹ typically represents one or more elements selected from the group consisting of gallium (Ga), aluminum (A¹), magnesium (Mg), zinc (Zn), and scandium (Sc). A¹ is preferably one or more elements selected from the group consisting of gallium (Ga) and aluminum (A¹), and more preferably two elements of Ga and A¹ from the viewpoint of further improving the moisture resistance and reaction resistance.

In the general formula (2), B¹ represents a metal element occupying a La site in the garnet type crystal structure. B¹ typically represents one or more elements selected from the group consisting of calcium (Ca), strontium (Sr), barium (Ba), and lanthanoid elements. Examples of the lanthanoid elements include cerium (Ce), praseodymium (Pr), neodymium (Nd), promethium (Pm), samarium (Sm), europium (Eu), gadolinium (Gd), terbium (Tb), dysprosium (Dy), holmium (Ho), erbium (Er), thulium (Tm), ytterbium (Yb), and lutetium (Lu).

In the formula (2), D¹ refers to a metal element occupying the six-coordination site in the garnet type crystal structure. The six-coordination site in the garnet type crystal structure is, for example, a site occupied by Nb in Li₅La₃Nb₂O₁₂ (ICDD Card No. 00-045-0109) having a garnet type crystal structure, and a site occupied by Zr in Li₇La₃Zr₂O₁₂ (ICDD Card. No 01-078-6708) having a garnet type crystal structure. D¹ represents one or more elements selected from the group consisting of transition elements capable of being six-coordinate with oxygen and typical elements belonging to Groups 12 to 15. Examples of the transition elements capable of being six-coordinate with oxygen include scandium (Sc), zirconium (Zr), titanium (Ti), tantalum (Ta), niobium (Nb), hafnium (Hf), molybdenum (Mo), tungsten (W), and tellurium (Te). Examples of the typical elements belonging to Groups 12 to 15 include indium (In), germanium (Ge), tin (Sn), lead (Pb), antimony (Sb), and bismuth (Bi). D¹ is typically one or more elements selected from the group consisting of Zr (zirconium), Sn (tin), Sb (antimony), Ti (titanium), Ta (tantalum), Nb (niobium), Hf (hafnium), Mo (molybdenum), W (tungsten), and Te (tellurium), and from the viewpoint of further improving the moisture resistance and the reaction resistance, preferably includes one or more elements selected from the group consisting of Zr (zirconium), Ta (tantalum), and Nb (niobium), and more preferably includes Zr (zirconium).

In the formula (2), x satisfies 0≤x≤1.00, and from the viewpoint of further improving the moisture resistance and the reaction resistance, preferably satisfies 0≤x≤0.70, more preferably 0≤x≤0.40, still more preferably 0≤x≤0.40, and particularly preferably 0≤x≤0.20.

y satisfies 0≤y≤0.50, and from the viewpoint of further improving the moisture resistance and the reaction resistance, y preferably satisfies 0≤y≤0.40, more preferably 0≤y≤0.30, and still more preferably 0≤y≤0.20.

β satisfies 2.5≤β≤3.5, and from the viewpoint of further improving the moisture resistance and the reaction resistance, preferably 2.7≤β≤3.3, more preferably 2.8≤β≤3.2, and still more preferably 2.9≤β≤3.1.

z satisfies 0≤z≤2.00, and from the viewpoint of further improving the moisture resistance and the reaction resistance, preferably satisfies 0≤z≤1.00, more preferably 0≤z≤0.50, and still more preferably 0.

γ satisfies 1.5≤y≤2.5, and from the viewpoint of further improving the moisture resistance and the reaction resistance, preferably 1.7≤γ≤2.3, more preferably 1.8≤γ≤2.2, and still more preferably 1.9≤γ≤2.0.

In the formula (2), p typically satisfies 6.0≤p≤7.0, and from the viewpoint of further improving the moisture resistance and the reaction resistance, preferably satisfies 6.0≤p≤6.6, more preferably 6.25≤p≤6.55.

a is the average valence of A¹. The average valence of A¹ is, for example, a value represented by (n1×a+n2×b+n3×c)/(n1+n2+n3) in a case where the number of elements X having a valence of a+ is n1, the number of elements Y having a valence of b+ is n2, and the number of elements Z having a valence of c+ is n3 in the elements represented by A¹.

b is the average valence of B¹. The average valence of B¹ is, for example, the same value as the above-described average valence of A¹ in a case where the number of elements X having a valence of a+ is n1, the number of elements Y having a valence of b+ is n2, and the number of elements Z having a valence of c+ is n3 in the elements represented by B¹.

c is the average valence of D¹. The average valence of D¹ is, for example, the same value as the average valence of A¹ mentioned above when D¹ is recognized as n1 elements X with a valence a+, n2 elements Y with a valence b+, and n3 elements Z with a valence c+.

δ represents an oxygen deficiency amount, and may be 0. δ is usually to satisfy 0≤δ<1. The oxygen deficiency amount δ cannot be quantitatively analyzed using the latest device, and therefore may be regarded as 0.

The molar ratio of each element in the chemical composition of the solid electrolyte ceramic of the present disclosure does not necessarily coincide with, for example, the molar ratio of each element in the general formula (2), and tends to deviate from this molar ratio according to the analysis method, but an effect of the present disclosure is exhibited as long as the compositional deviation does not change the properties.

In the present disclosure, the chemical composition of the solid electrolyte ceramic may be the composition of the whole ceramic material determined using an inductively coupled plasma method (ICP). The chemical composition may be measured and calculated using inductively coupled plasma atomic emission spectrometry (ICP-AES) or laser ablation inductively coupled plasma mass spectrometry (LA-ICP-MS). The chemical composition may be measured and calculated using XPS analysis, or may be determined using energy dispersive X-ray spectroscopy (TEM-EDX) and/or wavelength dispersive X-ray spectroscopy (WDX). The chemical composition may be obtained by performing quantitative analysis (composition analysis) at arbitrary 100 points of each of arbitrary 100 sintered grains and calculating the average of the resulting values.

Specific examples of the garnet type solid electrolyte represented by the general formula (2) include Li_{6.6}La₃Zr_{1.6}Ta_{0.4}O₁₂, Li_{6.4}Ga_{0.05}Al_{0.15}La₃Zr₂O₁₂, Li_{6.75}La₃Zr_{1.75}Nb_{0.25}O₁₂, and Li_{6.53}La₃Zr_{1.53}Ta_{0.4}Bi_{0.07}O₁₂.

The LISICON type crystal structure of the solid electrolyte encloses a β_{I} structure, a β_{II} type structure, a β_{II}′ type structure, a T_{I} type structure, a T_{II}, type structure, a γ_{II} type structure, and a γ₀ type structure. That is, the LISICON type solid electrolyte may include one or more solid electrolytes having a β_{I} structure, a β_{II} type structure, a β_{II}′ type structure, a T_{I} type structure, a T_{II}, type structure, a γ_{II} type structure, a γ₌₀ type structure, or a composite structure thereof. The LISICON type structure of the solid electrolyte is preferably a γ_{II} type structure from the viewpoint of further improving the moisture resistance and the reaction resistance.

The fact that the solid electrolyte has a γ_{II} type structure means that the solid electrolyte has a γ_{II} type crystal structure, and in a broad sense, means having a crystal structure that can be recognized as a γ_{II} type crystal structure by those skilled in the field of solid-state batteries. In a narrow sense, the fact that the solid electrolyte has a γ_{II} type structure means that the solid electrolyte shows one or more main peaks corresponding to a Miller index unique to a so-called γ_{II} Li₃VO₄ type crystal structure at a predetermined incident angle in X-ray diffraction. The compound that has a γ_{II} type structure (that is, solid electrolyte) is described, for example, in the document “J. solid state chem” (A. R. West et. al, J. solid state chem., 4, 20-28 (1972)), and example thereof include ICDD Card No. 01-073-2850.

The fact that the solid electrolyte has a β_{I} type structure means that the solid electrolyte has a β_{I} type crystal structure, and in a broad sense, means having a crystal structure that can be recognized as a β_{I} type crystal structure by those skilled in the field of solid-state batteries. In a narrow sense, the fact that the solid electrolyte has a β_{I} type structure means that the solid electrolyte shows one or more main peaks corresponding to a Miller index unique to a so-called β_{I}-Li₃VO₄ type crystal structure at a predetermined incident angle in X-ray diffraction. The compound that has a β_{I} type structure (that is, solid electrolyte) is described, for example, in the document “J. solid state chem” (A. R. West et. al, J. solid state chem., 4, 20-28 (1972)), and as an example thereof, the following table shows, for example, the XRD data (the d-value of plane spacing and the corresponding Miller indices) listed therein.

TABLE 1

Li [symbol] CoSiO [symbol]
β [symbol] 25° C.

| d(Å) | [symbol] | hk [symbol] |
|---|---|---|
| 5.4 | 80 | 110 |
| 4.08 | 60 | 120 |
| 3.88 | 60 | 101 |
| 3.65 | 100 | 111, 021 |
| 3.14 | 20 | 200, 121 |
| 3.10 | 40 | 130 |
| 2.71 | 80 | 220 |
| 2.68 | 60 | 040 |
| 2.47 | 80 | 002 |
| 2.38 | 60 | 221 |
| 2.36 | 20 | 041 |

[symbol]

indicates data missing or illegible when filed

The fact that the solid electrolyte has a β_{II} type structure means that the solid electrolyte has a β₁₁ type crystal structure, and in a broad sense, means having a crystal structure that can be recognized as a β_{II} type crystal structure by those skilled in the field of solid-state batteries. In a narrow sense, the fact that the solid electrolyte has a β_{II} type structure means that the solid electrolyte shows one or more main peaks corresponding to a Miller index unique to a so-called β_{II}-Li₃VO₄ type crystal structure at a predetermined incident angle in X-ray diffraction. The compound that has a β_{II} type structure (that is, solid electrolyte) is described, for example, in the document “J. solid state chem” (A. R. West et. al, J. solid state chem., 4, 20-28 (1972)), and example thereof include ICDD Card No. 00-024-0675.

The fact that the solid electrolyte has a β_{II}′ type structure means that the solid electrolyte has a β_{II}′ type crystal structure, and in a broad sense, means having a crystal structure that can be recognized as a β_{II}′ type crystal structure by those skilled in the field of solid-state batteries. In a narrow sense, the fact that the solid electrolyte has a β_{II}′ type structure means that the solid electrolyte shows one or more main peaks corresponding to a Miller index unique to a so-called β_{II}′-Li₃VO₄ type crystal structure at a predetermined incident angle in X-ray diffraction. The compound that has a β_{II}′ type structure (that is, solid electrolyte) is described, for example, in the document “J. solid state chem” (A. R. West et. al, J. solid state chem., 4, 20-28 (1972)), and as an example thereof, the following table shows, for example, the XRD data (the d-value of plane spacing and the corresponding Miller indices) listed therein.

TABLE 2

Li [symbol] CoGeO [symbol]
β [symbol] 25° C.

| d(Å) | [symbol] | hk [symbol] |
|---|---|---|
| | | 010 |
| 4.17 | 80 | 110 |
| 3.96 | 80 | 101 |
| 3.70 | 10 | 011 |
| 3.20 | 20 | 200, 111 |
| 2.75 | 100 | 210 |
| 2.74 | 60 | 020 |
| 2.50 | 80 | 002 |
| | | 120 |

[symbol]

indicates data missing or illegible when filed

The fact that the solid electrolyte has a T_{I} type structure means that the solid electrolyte has a T_{I} type crystal structure, and in a broad sense, means having a crystal structure that can be recognized as a T_{I} type crystal structure by those skilled in the field of solid-state batteries. In a narrow sense, the fact that the solid electrolyte has a T_{I} type structure means that the solid electrolyte shows one or more main peaks corresponding to a Miller index unique to a so-called T_{I}-Li₃VO₄ type crystal structure at a predetermined incident angle in X-ray diffraction. The compound that has a T_{I} type structure (that is, solid electrolyte) is described, for example, in the document “J. solid state chem” (A. R. West et. al, J. solid state chem., 4, 20-28 (1972)), and example thereof include ICDD Card No. 00-024-0668.

The fact that the solid electrolyte has a T_{II} type structure means that the solid electrolyte has a T_{II} type crystal structure, and in a broad sense, means having a crystal structure that can be recognized as a T_{II} type crystal structure by those skilled in the field of solid-state batteries. In a narrow sense, the fact that the solid electrolyte has a T_{II} type structure means that the solid electrolyte shows one or more main peaks corresponding to a Miller index unique to a so-called T_{II}-Li₃VO₄ type crystal structure at a predetermined incident angle in X-ray diffraction. The compound that has a T_{II} type structure (that is, solid electrolyte) is described, for example, in the document “J. solid state chem” (A. R. West et. al, J. solid state chem., 4, 20-28 (1972)), and example thereof include ICDD Card No. 00-024-0669.

The fact that the solid electrolyte has a γ₀ type structure means that the solid electrolyte has a γ₀ type crystal structure, and in a broad sense, means having a crystal structure that can be recognized as a γ₀ type crystal structure by those skilled in the field of solid-state batteries. In a narrow sense, the fact that the solid electrolyte has a γ₀ type structure means that the solid electrolyte shows one or more main peaks corresponding to a Miller index unique to a so-called γ₀-Li₃VO₄ type crystal structure at a predetermined incident angle in X-ray diffraction. The compound that has a γ₀ type structure (that is, solid electrolyte) is described, for example, in the document “J. solid state chem” (A. R. West et. al, J. solid state chem., 4, 20-28 (1972)), and as an example thereof, the following table shows, for example, the XRD data (the d-value of plane spacing and the corresponding Miller indices) listed therein.

TABLE 3

| | Li [symbol] CoSiO [symbol] | | |
|---|---|---|---|
| | [symbol] 25° C. | | |
| d(Å) | [symbol] | | hk [symbol] |
| 5.4 | 60 | | 110, 020 |
| 4.08 | 80 | | 120 |
| 3.92 | 60 | | 101 |
| 3.69 | 20 | | 111, 021 |
| | | {close oversize brace} | |
| 3.67 | 100 | | |
| 3.16 | 20 | | 121 |
| 3.10 | 60 | | 200, 130, 210 |
| 2.90 | 20 | | 031 |
| 2.71 | 100 | | 220 |
| 2.68 | 60 | | 040 |
| 2.65 | 20 | | 131 |
| | | {close oversize brace} | |
| 2.64 | 20 | | |
| 2.59 | 20 | | 211 |
| | | {close oversize brace} | |
| 2.57 | 20 | | |
| 2.51 [symbol] | 100 | | 002 |

[symbol]

indicates data missing or illegible when filed

The solid electrolyte having a LISICON type crystal structure may have any chemical composition. The LISICON type solid electrolyte has, for example, a chemical composition represented by the following general formula (3).

$$( {Li}_{3 - a x + ( 5 - b ) ( 1 - y ) ]} {A}_{x} ) ( {V}_{y} {B}_{1 - y} ) {O}_{4} \qquad ( 3 )$$

In the formula (3), A is one or more elements selected from the group consisting of Na (sodium), K (potassium), Mg (magnesium), Ca (calcium), Al (aluminum), Ga (gallium), Zn (zinc), Fe (iron), Cr (chromium), and Co (cobalt).

B is one or more elements selected from the group consisting of Zn (zinc), Al (aluminum), Ga (gallium), Si (silicon), Ge (germanium), Sn (tin), P (phosphorus), As (arsenic), Ti (titanium), Mo (molybdenum), W (tungsten), Fe (iron), Cr (chromium), and Co (cobalt), and from the viewpoint of further improving the moisture resistance and the reaction resistance, preferably one or more elements selected from the group consisting of Si (silicon) and P (phosphorus), and more preferably Si (silicon) or P (phosphorus).

x has a relationship of 0≤x≤1.0, particularly 0≤x≤0.2, and from the viewpoint of further improving the moisture resistance and the reaction resistance, preferably a relationship of 0≤x≤0.1, and more preferably 0.

y has a relationship of 0≤y≤1.0, and from the viewpoint of further improving the moisture resistance and the reaction resistance, preferably a relationship of 0≤y≤0.85.

a is an average valence of A. The average valence of A is, for example, a value represented by (n1×a+n2×b+n3×c)/(n1+n2+n3) when A is recognized as n1 of elements X having a valence a+, n2 of elements Y having a valence b+, and n3 of elements Z having a valence c+.

b is an average valence of B. The average valence of B is, for example, the same value as the average valence of A described above when B is recognized as n1 of elements X having a valence a+, n2 of elements Y having a valence b+, and n3 of elements Z having a valence c+.

Specific examples of the LISICON type solid electrolyte represented by the general formula (3) include Li_{3.2}V_{0.8}Si_{0.2}O₄ and Li_{3.5}P_{0.5}Si_{0.5}O₄.

The fact that the solid electrolyte has a perovskite type crystal structure means, in an encompassing manner, that the solid electrolyte not only simply has a “crystal structure of a perovskite type”, but also has a “crystal structure resembling a perovskite type”. Specifically, the solid electrolyte has a crystal structure that can be identified as a crystal structure of a perovskite type or resembling a perovskite type by those skilled in the field of solid-state batteries in X-ray diffraction. More specifically, the solid electrolyte may show, in X-ray diffraction, one or more main peaks corresponding to a Miller index unique to a so-called crystal structure of a perovskite type (diffraction pattern: ICDD Card No. 00-046-0465) at a predetermined incident angle, or as a crystal structure resembling a perovskite type, one or more main peaks corresponding to a Miller index unique to a so-called crystal structure of a perovskite type may show one or more main peaks having different incident angles (that is, peak positions or diffraction angles) and intensity ratios (that is, peak intensities or diffraction intensity ratios) due to a difference in composition. Examples of a typical diffraction pattern of a crystal structure resembling a perovskite type include ICDD Card No. 00-046-0466.

The solid electrolyte having a perovskite type crystal structure may have any chemical composition. The perovskite type solid electrolyte has, for example, a chemical composition represented by the following general formula (4).

$${Li}_{3 x} {La}_{2 / 3 - x} {TiO}_{3} \qquad ( 4 )$$

It is preferable to have an average chemical composition represented by the above formula.

In the formula (4), x preferably satisfies 0.09<x<0.167. Further, it is more preferable that 0.10<x<0.12.

Specific examples of the perovskite type solid electrolyte represented by the general formula (4) include Li_{0.35}La_{0.55}TiO₃ and Li_{0.5}La_{0.5}TiO₃.

The chemical composition of the solid electrolyte means the average value of the chemical composition of the solid electrolyte in the thickness direction of the layer containing the solid electrolyte (for example, the solid electrolyte layer). The average chemical composition of the solid electrolyte can be analyzed and measured by breaking the solid-state battery and performing composition analysis by energy-dispersive X-ray spectroscopy (EDX) using SEM-EDX in a field of view in which the entire layer fits in the thickness direction.

The solid electrolyte may be obtained by the same method as in the case of the oxide ceramic except that a raw material compound containing a predetermined metal atom is used, or may be obtained as a commercially available product.

From the viewpoint of suppressing deterioration of the battery in a longer period of time, all the layers constituting the battery element 1 may be integrally sintered as sintered bodies together between two adjacent layers. The statement that all the layers are integrally sintered as sintered bodies together between two adjacent layers means that the two adjacent layers are joined by sintering. Specifically, both the two adjacent layers are sintered bodies and further integrally sintered. Not the whole of the two adjacent layers need to be strictly integrated, and a portion thereof does not have to be integrated. Two adjacent layers may be integrated as a whole. For example, the positive electrode layer 1a, the solid electrolyte layer 1b, and the negative electrode layer 1a may be integrally sintered in a predetermined stacking order.

### Positive Electrode Layer and Negative Electrode Layer

The positive electrode layer is a so-called positive electrode active material layer and may additionally include the positive electrode current collecting layer. When the positive electrode layer has the positive electrode current collecting layer, the positive electrode layer may be provided on one side or on both sides of the positive electrode current collecting layer. The positive electrode layer is formed of a sintered body containing positive electrode active material grains and may be typically formed of a sintered body including positive electrode active material grains, electron conductive material grains, and solid electrolyte grains contained in the solid electrolyte layer. The positive electrode layer (particularly the positive electrode active material layer) may include the first solid electrolyte described above.

The negative electrode layer is a so-called negative electrode active material layer and may additionally include the negative electrode current collecting layer. When the negative electrode layer has the negative electrode current collecting layer, the negative electrode layer may be provided on one side or on both sides of the negative electrode current collecting layer. The negative electrode layer is formed of a sintered body including negative electrode active material grains and may be formed of a sintered body including negative electrode active material grains, electron conductive material grains, and solid electrolyte grains contained in the solid electrolyte layer. The negative electrode layer (particularly the negative electrode active material layer) may include the first solid electrolyte described above.

The positive electrode active material contained in the positive electrode layer and the negative electrode active material contained in the negative electrode layer are substances involved in the transfer of electrons in the solid-state battery, and ions contained in the solid electrolyte material constituting the solid electrolyte layer move (conduct) between the positive electrode and the negative electrode to transfer electrons, whereby charging and discharging are performed. Mediating ions are not particularly limited as long as charge and discharge can be performed, and examples thereof include lithium ions and sodium ions (particularly, lithium ions). The positive electrode layer and the negative electrode layer may be layers particularly capable of occluding and releasing lithium ions. That is, the solid-state battery according to the present disclosure may be a solid-state secondary battery in which lithium ions move between the positive electrode and the negative electrode with the solid electrolyte layer interposed therebetween to charge and discharge the battery.

The positive electrode active material included in the positive electrode layer is not particularly limited, and examples thereof include at least one selected from the group consisting of a lithium-containing phosphoric acid compound having a NASICON type structure, a lithium-containing phosphoric acid compound having an olivine type structure, a lithium-containing layered oxide, a lithium-containing oxide having a spinel type structure, and the like. One example of the lithium-containing phosphate compound having a NASICON type structure includes Li₃V₂(PO₄)₃. Examples of the lithium-containing phosphate compound having an olivine type structure include Li₃Fe₂(PO₄)₃ and LiMnPO₄. Examples of the lithium-containing layered oxide include LiCoO₂ and LiCo_{1/3}Ni_{1/3}Mn_{1/3}O₂. Examples of the lithium-containing oxide having a spinel type structure include LiMn₂O₄ and LiNi_{0.5}Mn_{1.5}O₄.

The negative electrode active material included in the negative electrode layer is not particularly limited, and examples thereof include at least one selected from the group consisting of an oxide containing at least one element selected from the group consisting of Ti, Si, Sn, Cr, Fe, Nb, and Mo, a graphite-lithium compound, a lithium alloy, a lithium-containing phosphoric acid compound having a NASICON type structure, a lithium-containing phosphoric acid compound having an olivine type structure, a lithium-containing oxide having a spinel type structure, and an oxide having a β-Li₃VO₄ type structure or a γ-Li₃VO₄ type structure. Examples of the lithium alloys include Li—Al. One example of the lithium-containing phosphate compound having a NASICON type structure includes Li₃V₂(PO₄)₃. One example of the lithium-containing phosphate compound having an olivine type structure includes Li₃Fe₂(PO₄)₃. Examples of the lithium-containing oxides that have a spinel type structure include Li₄Ti₅O₁₂. Examples of the negative electrode active material having a β-Li₃VO₄ type structure include Li₃VO₄. Examples of the oxide having a γ-Li₃VO₄ type structure include Li_{3.2}V_{0.8}Si_{0.2}O₄.

The electron conductive material included in the positive electrode layer and the negative electrode layer is not particularly limited, and examples thereof include a metal material such as silver, palladium, gold, platinum, aluminum, copper, or nickel, and a carbon material. In particular, carbon is preferable because carbon hardly reacts with the positive electrode active material, the negative electrode active material, and the solid electrolyte material, and has an effect of reducing the internal resistance of the solid-state battery.

The solid electrolyte material included in the positive electrode layer and the negative electrode layer may be selected from, for example, the same materials as the solid electrolyte material that can be included in the solid electrolyte layer described later.

The positive electrode layer and the negative electrode layer may each independently included a sintering agent. The sintering agent is not particularly limited, and may be, for example, at least one selected from the group consisting of lithium oxide, sodium oxide, potassium oxide, boron oxide, silicon oxide, bismuth oxide, and phosphorus oxide.

Thicknesses of the positive electrode layer and the negative electrode layer are not particularly limited, and may be each independently, for example, 2 μm to 50 μm, particularly 5 μm to 30 μm.

### Solid Electrolyte Layer

The solid electrolyte layer may include a sintering agent. The sintering agent included in the solid electrolyte layer may be selected from, for example, the same materials as the sintering agent that can be included in the positive electrode layer and the negative electrode layer.

A thickness of the solid electrolyte layer is not particularly limited, and may be, for example, 1 μm to 15 μm, particularly 1 μm to 5 μm.

### (External Electrode)

The external electrode 3 is a member for drawing electric power (in particular, current) generated in the battery element 1 to the outside. The external electrode 3 encompasses a positive electrode side external electrode and a negative electrode side external electrode. The external electrode 3 may have a form of a sintered body from the viewpoints of reducing the production cost of the solid-state battery by integral firing and reducing the internal resistance of the solid-state battery.

When having the form of a sintered body, the external electrode 3 may be formed of, for example, a sintered body including electron conductive material particles and a sintering agent. The electron conductive material included in the external electrode 3 may be selected from, for example, the same materials as the electron conductive material that can be included in the positive electrode layer and the negative electrode layer. The sintering aid included in the external electrode 3 may be selected from, for example, the same materials as the sintering agent that can be included in the positive electrode layer and the negative electrode layer.

### [Method for Producing Solid-State Battery]

A method for producing the solid-state battery of the present disclosure includes: a step of forming an unfired stacked body; and a step of firing the unfired stacked body.

### (Step of Forming Unfired Stacked Body)

The unfired stacked body can be produced by a printing method such as a screen printing method, a green sheet method using a green sheet, an immersion method, or a composite method thereof, but is obviously not limited to these methods.

For example, the solid electrolyte layer and the main surface exterior portion are produced by a green sheet method. An electrode layer (positive electrode layer and/or negative electrode layer) and an insulating portion are formed on the obtained solid electrolyte layer sheet by a printing method. After the solid electrolyte layer sheet on which the electrode layer and the like are printed and the main surface exterior portion sheet are stacked in a predetermined order, the side surface exterior portion is formed by an immersion method. Thereafter, the external electrode is formed by an immersion method. As a result, the unfired stacked body is formed.

### (Firing Step)

The unfired stacked body is subjected to firing. The firing is performed by removing an organic material at, for example, 500° C. in a nitrogen gas atmosphere including oxygen gas, and then heating was performed at, for example, 550° C. to 1300° C.

The present disclosure as described above encompasses the following preferable aspects.

<1> A solid-state battery having an exterior portion including an oxide ceramic containing: Li; Mg; and one or more elements (M) selected from Group 4 and Group 5 elements.

<2> The solid-state battery according to <1>, in which the oxide ceramic has a molar ratio of 0<Li/M≤5.

<3> The solid-state battery according to <1> or <2>, in which the oxide ceramic has a molar ratio of 0.1≤Mg/M≤9.8.

<4> The solid-state battery according to <1> to <3>, in which the oxide ceramic has a molar ratio of 0.8≤Li/M≤4.2.

<5> The solid-state battery according to <1> to <4>, in which the oxide ceramic has a molar ratio of 0.3 Mg/M≤9.8.

<6> The solid-state battery according to <1> to <5>, in which the oxide ceramic has a molar ratio of 0.8≤Li/M≤2.1.

<7> The solid-state battery according to <1> to <6>, in which the oxide ceramic has a molar ratio of 0.8≤Mg/M≤4.2.

<8> The solid-state battery according to any one of <1> to <7>, in which the oxide ceramic has a rock salt crystal structure, a spinel crystal structure, a layered rock salt crystal structure, or a mixed phase structure.

<9> The solid-state battery according to any one of <1> to <8>, in which the oxide ceramic has a rock salt crystal structure.

<10> The solid-state battery according to any one of <1> to <9>, in which the element (M) is at least one selected from Ti, Zr, Hf, Ta, and Nb.

<11> The solid-state battery according to any one of <1> to <10>, in which the element (M) includes Ti or Zr and Ta.

<12> The solid-state battery according to any one of <1> to <11>, in which the solid-state battery further includes a battery element covered with the exterior portion, and the battery element includes at least one solid electrolyte selected from a garnet solid electrolyte, a LISICON solid electrolyte, and a perovskite solid electrolyte.

<13> The solid-state battery according to <12>, in which the battery element includes a garnet solid electrolyte or a LISICON solid electrolyte.

<14> The solid-state battery according to <12> or <13>, in which the battery element includes a garnet solid electrolyte.

<15> The solid-state battery according to any one of <12> to <14>, in which the exterior portion has a layered form.

<16> The solid-state battery according to any one of <12> to <15>, in which the exterior portion is in direct contact with a surface of the battery element.

<17> The solid-state battery according to any one of <12> to <16>, in which the exterior portion and a surface of the battery element are an integrally sintered body.

<18> The solid-state battery according to any one of <12> to <17>, in which the battery element includes one or more battery constituent units including a positive electrode layer and a negative electrode layer facing each other and a solid electrolyte layer between the positive electrode layer and the negative electrode layer, and the solid electrolyte is included in one or more layers selected from the positive electrode layer, the negative electrode layer, and the solid electrolyte layer.

Hereinafter, the present disclosure will be described in more detail on the basis of specific examples, but the present disclosure is not limited to the following examples and can be appropriately changed and implemented without changing the gist of the present disclosure.

### EXAMPLES

### [Synthesis of Oxide Ceramic]

Raw materials including lithium carbonate (Li₂CO₃), magnesium oxide (MgO), titanium oxide (TiO₂), niobium oxide (Nb₂O₅), zirconium oxide (ZrO₂), tantalum oxide (Ta₂O₅), and hafnium oxide (HfO₂) were weighed such that the composition of the main phase was as shown in the following table. Then, water was added, the resulting mixture was enclosed in a polyethylene polypot, and the polypot was rotated on a pot rack at 150 rpm for 16 hours to mix the raw materials. Incidentally, lithium carbonate as a Li source was charged in an excess amount of 5% by mass with respect to the target composition in consideration of Li deficiency during sintering.

Then, the resulting slurry was dried, and then pre-fired at 1050° C. for 5 hours. A mixed solvent of toluene and acetone was added to the resulting pre-fired product, and the mixture was pulverized with a planetary ball mill for 12 hours and then dried to provide an oxide ceramic having the composition shown in Comparative Examples 5 and 6 and Examples 1 to 26.

### [Evaluation of Moisture Resistance]

### Preparation of Sintered Body

The obtained oxide ceramic was kneaded with a butyral resin, an alcohol, and a binder to produce a slurry. The slurry was sheet-molded on a PET film using a doctor blade method to obtain a sheet. The prepared sheet was stacked until the thickness of the sheet reached 1.5 mm, and then cut into a square having a side of 10 mm in plan view. In order to suppress Li volatilization, the stacked body was sufficiently covered with a mother powder, and then fired at a temperature of 400° C. to remove the butyral resin, and then fired at 1150 to 1300° C. for 2 hours, and then cooled to provide an exterior ceramic single plate. It was confirmed that all the sintered bodies had a relative density of 95% or more by using the Archimedes method.

### Testing Method

The weight of the exterior ceramic single plate (sintered body) was measured.

The sintered body was held at 125° C. and 85% relative humidity for 96 hours in a pressure cooker test (PCT), and then the weight of the sintered body was measured again. The weight change before and after PCT was calculated and determined according to the following criteria. The weight change is represented by the ratio of the weight increase amount to the pre-PCT weight.
⊙: weight change was less than 1% (lower limit of measurement) (best);
∘: weight change was 1% to less than 5% (excellent);
Δ: weight change is 5% to less than 10% (pass: no problem in practical use); and
x: weight change was 10% or more, or powderized (failed: practical problem).

### [Evaluation of Reaction Resistance to Solid Electrolyte]

The oxide ceramic was mixed with a solid electrolyte, molded into a tablet shape, and then fired at 800° C. for 5 hours. After firing, the crystal phase was analyzed by XRD measurement and determined according to the following criteria. The tablet prepared in each of Comparative Examples and Examples was pulverized using a mortar and formed into a powder. The resulting powder was packed in a folder, and XRD measurement was performed using a CuKα ray under the conditions of a scan speed of 4.0°/min and an angle measurement range of 10° to 60° to evaluate the crystal phase included in the tablet. The solid electrolyte used in Comparative Examples 1 to 6 and Examples 1 to 19 was a garnet type solid electrolyte having a chemical composition of Li_{6.6}La₃Zr_{1.6}Ta_{0.4}O₁₂. The solid electrolyte used in Examples 20 to 26 was the garnet type solid electrolyte, the LISICON type solid electrolyte, or the perovskite type solid electrolyte shown in Table 7.
∘: “no decomposition” of solid electrolyte and oxide ceramic (excellent);
Δ: “partial decomposition” of solid electrolyte or oxide ceramic (pass: remaining of crystal phase) (no problem in practical use); and
x: “complete decomposition” of the solid electrolyte or the oxide ceramic (unacceptable: practical problem).

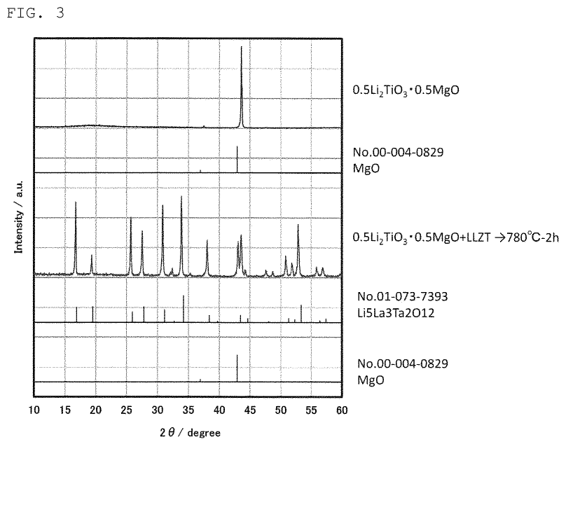

“No decomposition” means that, as shown in FIG. 3, in the XRD measurement after firing, all peaks derived from the oxide ceramic and the solid electrolyte before firing are clearly observed, and no side reaction proceeds between them. FIG. 3 shows XRD measurement result data when reaction resistance is determined in Example 4.

The “partial decomposition” means that, in XRD measurement after firing, all peaks derived from the oxide ceramic and the solid electrolyte before firing are observed, but a heterogeneous phase of the third phase is generated in part.

The “complete decomposition” means that, in XRD measurement after firing, a peak of at least one compound of peaks derived from an oxide ceramic and a solid electrolyte before firing is not observed.

A method for synthesizing the solid electrolyte used in the evaluation of reaction resistance is described below.

### [Synthesis of Garnet Type Solid Electrolyte]

Raw materials including lithium hydroxide monohydrate (LiOH·H₂O), gallium oxide (Ga₂O₃), aluminum oxide (Al₂O₃), lanthanum hydroxide (La(OH)₃), zirconium oxide (ZrO₂), niobium oxide (Nb₂O₅), tantalum oxide (Ta₂O₅), and bismuth oxide (Bi₂O₃) were weighed such that the solid electrolyte had a predetermined composition. Then, water was added, the resulting mixture was enclosed in a polyethylene polypot, and the polypot was rotated on a pot rack at 150 rpm for 16 hours to mix the raw materials. 3% by mass of excess lithium hydroxide monohydrate (LiOH·H₂O) as a Li source was put based on the target composition in consideration of Li deficiency during sintering.

Then, the obtained slurry was dried and then pre-fired at 1000° C. for 5 hours to provide a solid electrolyte powder having a predetermined composition.

### [Synthesis of LISICON Type Solid Electrolyte]

Raw materials including lithium hydroxide monohydrate (LiOH·H₂O), lithium phosphate (Li₃PO₄), vanadium oxide (V₂O₅), and silicon oxide (SiO₂) were weighed such that the solid electrolyte had a predetermined composition. Then, water was added, the resulting mixture was enclosed in a polyethylene polypot, and the polypot was rotated on a pot rack at 150 rpm for 16 hours to mix the raw materials. 3% by mass of excess lithium hydroxide monohydrate (LiOH·H₂O) as a Li source was put based on the target composition in consideration of Li deficiency during sintering.

Then, the obtained slurry was dried and then pre-fired at 900° C. for 5 hours to provide a solid electrolyte powder having a predetermined composition.

### [Synthesis of Perovskite Type Solid Electrolyte]

Raw materials including lithium hydroxide monohydrate (LiOH·H₂O), titanium oxide (TiO₂), and lanthanum hydroxide (La(OH)₃) were weighed such that the solid electrolyte had a predetermined composition. Then, water was added, the resulting mixture was enclosed in a polyethylene polypot, and the polypot was rotated on a pot rack at 150 rpm for 16 hours to mix the raw materials. 3% by mass of excess lithium hydroxide monohydrate (LiOH·H₂O) as a Li source was put based on the target composition in consideration of Li deficiency during sintering.

Then, the obtained slurry was dried and then pre-fired at 1000° C. for 5 hours to provide a solid electrolyte powder having a predetermined composition.

TABLE 4

| | | | | | | | | | Moisture resistance | | |
|---|---|---|---|---|---|---|---|---|---|---|---|
| | Oxide ceramic | | | | | | | | Weight | | Reaction |
| | Chemical | Li | Mg | M | | Li/M | Mg/M | Crystal | change | | resistance |
| | composition | (α1) | (β) | (γ) | δ | ratio | ratio | structure | rate | Determination | (1) |
| Comparative | Na₂O—SiO₂—B₂O₃ | — | — | — | — | — | — | Glass | <1% | ⊙ | X |
| Example 1 | | | | | | | | | | | |
| Comparative | Al₂O₃ | — | — | — | — | — | — | Corundum | <1% | ⊙ | X |
| Example 2 | | | | | | | | | | | |
| Comparative | MgO | 0.00 | 1.00 | 0.00 | 1.0 | — | — | Rock salt | 25% | X | ◯ |
| Example 3 | | | | | | | | | | | |
| Comparative | TiO₂ | 0.00 | 0.00 | 1.00 | 2.0 | — | — | Rutile | <1% | ⊙ | X |
| Example 4 | | | | | | | | | | | |
| Comparative | Li_{0.66}Ti_{0.33}O | 0.66 | 0.00 | 0.33 | 1.0 | — | — | Layered | 11% | X | ◯ |
| Example 5 | | | | | | | | rock salt | | | |
| Comparative | Li_{0.18}Mg_{0.82}O_{0.9} | 0.18 | 0.82 | 0.00 | 0.9 | — | — | Rock salt | 28% | X | ◯ |
| Example 6 | | | | | | | | | | | |
| Example 1 | Li_{0.17}Mg_{0.75}Ti_{0.08}O | 0.17 | 0.75 | 0.08 | 1.0 | 2 | 9.0 | Rock salt | 3% | ◯ | ◯ |
| Example 2 | Li_{0.29}Mg_{0.57}Ti_{0.14}O | 0.29 | 0.57 | 0.14 | 1.0 | 2 | 4.0 | Rock salt | <1% | ⊙ | ◯ |
| Example 3 | Li_{0.40}Mg_{0.40}Ti_{0.20}O | 0.40 | 0.40 | 0.20 | 1.0 | 2 | 2.0 | Rock salt | <1% | ⊙ | ◯ |
| Example 4 | Li_{0.50}Mg_{0.25}Ti_{0.25}O | 0.50 | 0.25 | 0.25 | 1.0 | 2 | 1.0 | Rock salt | <1% | ⊙ | ◯ |
| Example 5 | Li_{0.58}Mg_{0.13}Ti_{0.29}O | 0.58 | 0.13 | 0.29 | 1.0 | 2 | 0.4 | Rock salt | 2% | ◯ | ◯ |
| Example 6 | Li_{0.65}Mg_{0.03}Ti_{0.32}O | 0.65 | 0.03 | 0.32 | 1.0 | 2 | 0.1 | Layered | 5% | Δ | ◯ |
| | | | | | | | | rock salt | | | |

(1) Reaction resistance to Garnet type solid electrolyte. Chemical composition mainly indicates final composition.

As shown in Comparative Examples 1, 2, and 4, the glass material, Al₂O₃, TiO₂, and the like have moisture resistance, but have low reaction resistance to a solid electrolyte, and cannot be used as an exterior material.

From Comparative Examples 3 to 6, it was found that the oxide ceramic including one or two elements selected from Li, Mg, and M (for example, Ti) used in the present disclosure has a problem in either moisture resistance or reaction resistance to a solid electrolyte.

As shown in Examples 1 to 6, it was found that the oxide ceramic includes Li, Mg, and M (for example, Ti), thereby allowing to achieve both reaction resistance and moisture resistance to the solid electrolyte.

TABLE 5

| | | | | | | | | | Moisture resistance | | |
|---|---|---|---|---|---|---|---|---|---|---|---|
| | Oxide ceramic | | | | | | | | Weight | | Reaction |
| | | Li | Mg | M | | Li/M | Mg/M | Crystal | change | | resistance |
| | Chemical composition | (α1) | (β) | (γ) | δ | ratio | ratio | structure | rate | Determination | (1) |
| Example 7 | Li_{0.52}Mg_{0.24}Ti_{0.24}O | 0.52 | 0.24 | 0.24 | 1.0 | 2.2 | 1.0 | Rock salt | 2% | ◯ | ◯ |
| Example 8 | Li_{0.47}Mg_{0.26}Ti_{0.26}O | 0.47 | 0.26 | 0.26 | 1.0 | 1.8 | 1.0 | Spinel + | <1% | ⊙ | Δ |
| | | | | | | | | rock salt | | | |
| Example 9 | Li_{0.09}Mg_{0.83}Ti_{0.09}O | 0.09 | 0.83 | 0.09 | 1.0 | 1.0 | 9.5 | Rock salt | 3% | ◯ | ◯ |
| Example 10 | Li_{0.16}Mg_{0.76}Ti_{0.08}O | 0.16 | 0.76 | 0.08 | 1.0 | 2.0 | 9.5 | Rock salt | 2% | ◯ | ◯ |
| Example 11 | Li_{0.28}Mg_{0.66}Ti_{0.07}O_{0.9} | 0.28 | 0.66 | 0.07 | 0.9 | 4.0 | 9.5 | Rock salt | 3% | ◯ | ◯ |
| Example 12 | Li_{0.33}Mg_{0.58}Ti_{0.08}O_{0.9} | 0.33 | 0.58 | 0.08 | 0.9 | 4.0 | 7.0 | Rock salt | 3% | ◯ | ◯ |
| Example 13 | Li_{0.67}Mg_{0.17}Ti_{0.17}O_{0.8} | 0.67 | 0.17 | 0.17 | 0.8 | 4.0 | 1.0 | Layered | 7% | Δ | ◯ |
| | | | | | | | | rock salt | | | |
| Example 14 | Li_{0.25}Mg_{0.50}Ti_{0.25}O_{1.1} | 0.25 | 0.50 | 0.25 | 1.1 | 1.0 | 2.0 | Spinel + | <1% | ⊙ | Δ |
| | | | | | | | | rock salt | | | |

(1) Reaction resistance to Garnet type solid electrolyte

The results of Examples 1 to 14 show that satisfying the ranges of 0<Li/M≤5 and 0.1≤Mg/M≤9.8 can achieve both moisture resistance and reaction resistance to the solid electrolyte. Among these, from the viewpoint of further improving the reaction resistance to the solid electrolyte, the oxide ceramic preferably has a rock salt structure or a layered rock salt structure. From the viewpoint of moisture resistance, the oxide ceramic preferably has a rock-salt type structure and/or a spinel type structure, and more preferably has a rock salt type structure.

TABLE 6

| | | | | | | | | | Moisture resistance | | |
|---|---|---|---|---|---|---|---|---|---|---|---|
| | Oxide ceramic | | | | | | | | Weight | | Reaction |
| | | Li | Mg | M | | Li/M | Mg/M | Crystal | change | | resistance |
| | Chemical composition | (α1) | (β) | (γ) | δ | ratio | ratio | structure | rate | Determination | (1) |
| Example 15 | Li_{0.29}Mg_{0.57}Zr_{0.14}O | 0.29 | 0.57 | 0.14 | 1.0 | 2 | 4 | Rock salt | 3% | ◯ | ◯ |
| Example 16 | Li_{0.29}Mg_{0.57}Hf_{0.14}O | 0.29 | 0.57 | 0.14 | 1.0 | 2 | 4 | Rock salt | 2% | ◯ | ◯ |
| Example 17 | Li_{0.38}Mg_{0.50}Nb_{0.13}O | 0.38 | 0.50 | 0.13 | 1.0 | 3 | 4 | Rock salt | 2% | ◯ | ◯ |
| Example 18 | Li_{0.29}Mg_{0.57}(Ti_{0.07}Zr_{0.07})O | 0.29 | 0.57 | 0.14 | 1.0 | 2 | 4 | Rock salt | <1% | ⊙ | ◯ |
| Example 19 | Li_{0.33}Mg_{0.53}(Ti_{0.07}Ta_{0.07})O | 0.33 | 0.53 | 0.14 | 1.0 | 2 | 4 | Rock salt | <1% | ⊙ | ◯ |

(1) Reaction resistance to Garnet type solid electrolyte

From the results of Examples 15 to 19, it was found that satisfying the ranges of 0<Li/M≤5 and 0.1≤Mg/M≤9.8 can achieve both moisture resistance and reaction resistance to the solid electrolyte, if M includes an element of Group 4 or Group 5 other than Ti.

In addition, comparing Examples 1 to 5, 7, 9 to 12, and 15 to 19 with Examples 6, 8, 13, and 14, it was found that if the following conditions A1 to A3 are satisfied, the moisture resistance and the reaction resistance to the solid electrolyte are further improved, and the evaluation result of each property is “∘” or more excellent than “∘”.
Condition A1: 0.8≤Li/M≤4.2;
Condition A2: 0.3≤Mg/M≤9.8; and
Condition A3: oxide ceramic has a rock salt type structure.

Further, comparing Examples 2 to 4, 18, and 19 with Examples 1 and 5 to 17, it was found that if the following conditions B1 to B3 are satisfied, the moisture resistance and the reaction resistance to the solid electrolyte are further improved, and the moisture resistance is determined as “⊙” and the reaction resistance is determined as “∘”.
Condition B1: 0.8≤Li/M≤2.1;
Condition B2: 0.8≤Mg/M≤4.2; and
Condition B3: oxide ceramic has a rock salt type structure.

TABLE 7

| | | | Oxide ceramic | | | | | | | | Reaction |
|---|---|---|---|---|---|---|---|---|---|---|---|
| | Solid electrolyte used in | | Chemical | Li | Mg | M | | Li/M | Mg/M | Crystal | resistance |
| | reaction resistance evaluation | | composition | (α1) | (β) | (γ) | δ | ratio | ratio | structure | (1) |
| Example 20 | Li_{6.4}Ga_{0.05}Al_{0.15}La₃Zr₂O₁₂ | Garnet | Li_{0.29}Mg_{0.57}Ti_{0.14}O | 0.29 | 0.57 | 0.14 | 1.0 | 2 | 4 | Rock salt | ◯ |
| | | type | | | | | | | | | |
| Example 21 | Li_{6.75}La₃Zr_{1.75}Nb_{0.25}O₁₂ | Garnet | Li_{0.50}Mg_{0.25}Ti_{0.25}O | 0.50 | 0.25 | 0.25 | 1.0 | 2 | 1 | Rock salt | ◯ |
| | | type | | | | | | | | | |
| Example 22 | Li_{6.53}La₃Zr_{1.53}Ta_{0.4}Bi_{0.07}O₁₂ | Garnet | Li_{0.50}Mg_{0.25}Ti_{0.25}O | 0.50 | 0.25 | 0.25 | 1.0 | 2 | 1 | Rock salt | ◯ |
| | | type | | | | | | | | | |
| Example 23 | Li_{3.2}V_{0.8}Si_{0.2}O₄ | LISICON | Li_{0.50}Mg_{0.25}Ti_{0.25}O | 0.50 | 0.25 | 0.25 | 1.0 | 2 | 4 | Rock salt | ◯ |
| | | type | | | | | | | | | |
| Example 24 | Li_{3.5}P_{0.5}Si_{0.5}O₄ | LISICON | Li_{0.50}Mg_{0.25}Ti_{0.25}O | 0.50 | 0.25 | 0.25 | 1.0 | 2 | 1 | Rock salt | ◯ |
| | | type | | | | | | | | | |
| Example 25 | Li_{0.35}La_{0.55}TiO₃ | Perovskite | Li_{0.29}Mg_{0.57}Ti_{0.14}O | 0.29 | 0.57 | 0.14 | 1.0 | 2 | 4 | Rock salt | ◯ |
| | | type | | | | | | | | | |
| Example 26 | Li_{0.35}La_{0.55}TiO₃ | Perovskite | Li_{0.50}Mg_{0.25}Ti_{0.25}O | 0.50 | 0.25 | 0.25 | 1.0 | 2 | 1 | Rock salt | ◯ |
| | | type | | | | | | | | | |

(1) Reaction resistance to Garnet type solid electrolyte

It was found from Examples 20 to 26 that when various solid electrolytes were used, the oxide ceramic included in the exterior portion of the present disclosure did not cause side reactions during firing.

In Tables 4 to 7, the chemical compositions are formulae showing the final compositions.

The solid-state battery of the present disclosure can be used in various fields where use of a battery or storage of electricity is assumed. By way of example only, the solid-state battery of the present disclosure can be used in the field of electronics mounting. The solid-state battery according to an embodiment of the present disclosure can also be used in the fields of electricity, information, and communication in which mobile devices and the like are used (for example, electric and electronic equipment fields or mobile equipment fields including mobile phones, smartphones, smartwatches, notebook computers, and small electronic machines such as digital cameras, activity meters, arm computers, electronic papers, wearable devices, RFID tags, card-type electronic money, and smartwatches), home and small industrial applications (for example, the fields of electric tools, golf carts, and home, nursing, and industrial robots), large industrial applications (for example, the fields of forklift, elevator, and harbor crane), transportation system fields (for example, the fields of hybrid vehicles, electric vehicles, buses, trains, power-assisted bicycles, electric two-wheeled vehicles, and the like), power system applications (for example, fields such as various types of power generation, road conditioners, smart grids, and household power storage systems), medical applications (medical device fields such as hearing aid buds), pharmaceutical applications (fields such as dosage management systems), IoT fields, space and deep sea applications (for example, fields such as space probes and submersibles), and the like.

### DESCRIPTION OF REFERENCE SYMBOLS

1: Battery element
1a: Electrode layer (positive electrode layer and negative electrode layer)
1b: Solid electrolyte layer
1c: Insulating portion
2: Exterior portion
2a: Main surface exterior portion
2b: Side surface exterior portion
3: External electrode (external positive electrode and external negative electrode)

The invention claimed is:

1. A solid-state battery comprising:
an exterior portion including an oxide ceramic containing:
Li;
Mg; and
one or more elements (M) selected from Group 4 and Group 5 elements.

2. The solid-state battery according to claim 1, wherein the oxide ceramic has a first molar ratio of 0<Li/M≤5.

3. The solid-state battery according to claim 2, wherein the oxide ceramic has a second molar ratio of 0.1≤Mg/M≤9.8.

4. The solid-state battery according to claim 1, wherein the oxide ceramic has a molar ratio of 0.1≤Mg/M≤9.8.

5. The solid-state battery according to claim 1, wherein the oxide ceramic has a molar ratio of 0.8≤Li/M≤4.2.

6. The solid-state battery according to claim 1, wherein the oxide ceramic has a molar ratio of 0.3≤Mg/M≤9.8.

7. The solid-state battery according to claim 1, wherein the oxide ceramic has a molar ratio of 0.8≤Li/M≤2.1.

8. The solid-state battery according to claim 1, wherein the oxide ceramic has a molar ratio of 0.8≤Mg/M≤4.2.

9. The solid-state battery according to claim 1, wherein the oxide ceramic has a rock salt crystal structure, a spinel crystal structure, a layered rock salt crystal structure, or a mixed phase structure.

10. The solid-state battery according to claim 1, wherein the oxide ceramic has a rock salt crystal structure.

11. The solid-state battery according to claim 1, wherein the element (M) is at least one selected from Ti, Zr, Hf, Ta, and Nb.

12. The solid-state battery according to claim 1, wherein the element (M) includes Ti.

13. The solid-state battery according to claim 1, wherein
the solid-state battery further includes a battery element covered with the exterior portion, and
the battery element includes at least one solid electrolyte selected from a garnet solid electrolyte, a LISICON solid electrolyte, and a perovskite solid electrolyte.

14. The solid-state battery according to claim 13, wherein the battery element includes a garnet solid electrolyte or a LISICON solid electrolyte.

15. The solid-state battery according to claim 13, wherein the battery element includes a garnet solid electrolyte.

16. The solid-state battery according to claim 13, wherein the exterior portion has a layered form.

17. The solid-state battery according to claim 13, wherein the exterior portion is in direct contact with a surface of the battery element.

18. The solid-state battery according to claim 13, wherein the exterior portion and a surface of the battery element are an integrally sintered body.

19. The solid-state battery according to claim 13, wherein
the battery element includes one or more battery constituent units including a positive electrode layer and a negative electrode layer facing each other and a solid electrolyte layer between the positive electrode layer and the negative electrode layer, and
the solid electrolyte is included in one or more layers selected from the positive electrode layer, the negative electrode layer, and the solid electrolyte layer.
